(19) United States
(12) Patent Application Publication
(10) Pub. No.: US 2010/0005970 A1
(43) Pub. Date: Jan. 14, 2010

(54) Industrial air purifier

(75) Inventor: Hui-Hsiung Lee, Taipei (TW)

Correspondence Address: BACON & THOMAS, PLLC, 625 SLATERS LANE, FOURTH FLOOR, ALEXANDRIA, VA, 22314-1176, US

(73) Assignee: RACE AHEAD TECHNOLOGY LIMITED, Tortola (VG)

(21) Appl. No.: 12/216,936

(22) Filed: Jul. 14, 2008

(51) Int. Cl. B03C 3/38

(52) U.S. Cl. 96/16

(57) ABSTRACT

An air purifier for industrial plants has an air pump and a water cleaner and an ultraviolet (UV) cleaner. The air duct has an air outlet, air inlet, first duct casing and second duct casing. The first duct casing and the second ducting casing each has a top being connected by a connecting tube and are bigger than the air outlet. The water cleaner is mounted in the first duct casing of the air duct. The UV cleaner cleans and purifies dirty air and has multiple UV generators. The air purifier sprays water to contain particulates in the dirty air and decomposes the pollutants using UV. Since the dirty air in the air duct has enough reactive time to turn into the clean air, the air purifier without any air-cleaning agents generates clean air without air cleaning agents in the air to endanger people and the environment.

### BACKGROUND OF THE INVENTION

1. Field of the Invention

The present invention relates to a purifying device, particularly to an industrial air purifier having an expanded air duct for use in industrial plants to purify dirty air.

2. Description of Related Art

Industrial plants including but not limited to oil refineries and incinerators generate a large quantity of dirty air, which will pollute the ambient environment and endanger human health.

The dirty air comprises waste gases including, but not limited to hydrocarbons, nitroxides (NOₓ), sulfoxides (SOₓ), hydrocarbons (CₓH_{y}), carbon monoxide (CO), volatile organic matter (VOM) and polycyclic organic matter (POM) especially dioxins, particulates including but not limited to carbon and unburned matter.

Increased environmental controls require the dirty air to be cleaned before being discharged from the plant and becoming a significant hazard to ambient environment and people. Therefore, the plants must be equipped with an air purifier that purifies the dirty air.

Generally exhaust ducts guiding the dirty air outside the industrial plant contain filters to treat the dirty air while saving time and space of a dirty air treatment area. Alternatively, air cleansing agents are added to the exhaust ducts to chemically pull pollutants out of the air. However, the dirty air in the air duct does not have enough reactive time to have pollutants removed and remains dirty and may contain the cleansing agents when expulsed from the industrial plant creating possibilities of fines, lawsuits and reducing the plants and their goods' reputation amongst locals and environmentalists.

To overcome the shortcomings, the present invention provides an air purifier to mitigate or obviate the aforementioned problems.

### SUMMARY OF THE INVENTION

The main objective of the invention is to provide an air purifier that purifies dirty air. An air purifier for industry plants in accordance with the present invention comprises an air pump, a water cleaner and an ultraviolet (UV) cleaner. The air duct has an air outlet, air inlet, first duct casing and second duct casing. The first duct casing and the second ducting casing each has a top being connected by a connecting tube and are bigger than the air outlet. The water cleaner is mounted in the first duct casing of the air duct. The UV cleaner cleans and purifies dirty air and has multiple UV generators. The air purifier sprays water to contain particulates in the dirty air and decomposes the pollutants using UV. Since, the dirty air in the air duct has enough reactive time to turn into clean air, the air purifier generates clean air without air-cleaning agents neither smells nor discomforts people nor leaves remain air cleaning agents in the air to endanger people and the environment.

Other objectives, advantages and novel features of the invention will become more apparent from the following detailed description when taken in conjunction with the accompanying drawings.

### BRIEF DESCRIPTION OF THE DRAWINGS

FIG. 1 is a side view in partial section of an air purifier in accordance with the present invention with the water cleaner connected to the air duct, and

FIG. 2 is an enlarged side view in partial section of the water cleaner of the air purifier in FIG. 1.

### DETAILED DESCRIPTION OF THE PREFERRED EMBODIMENT

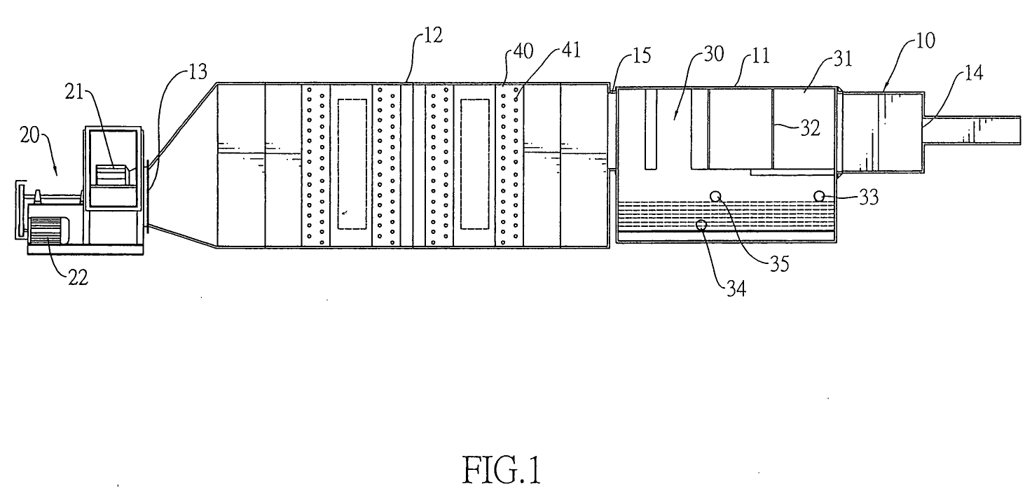

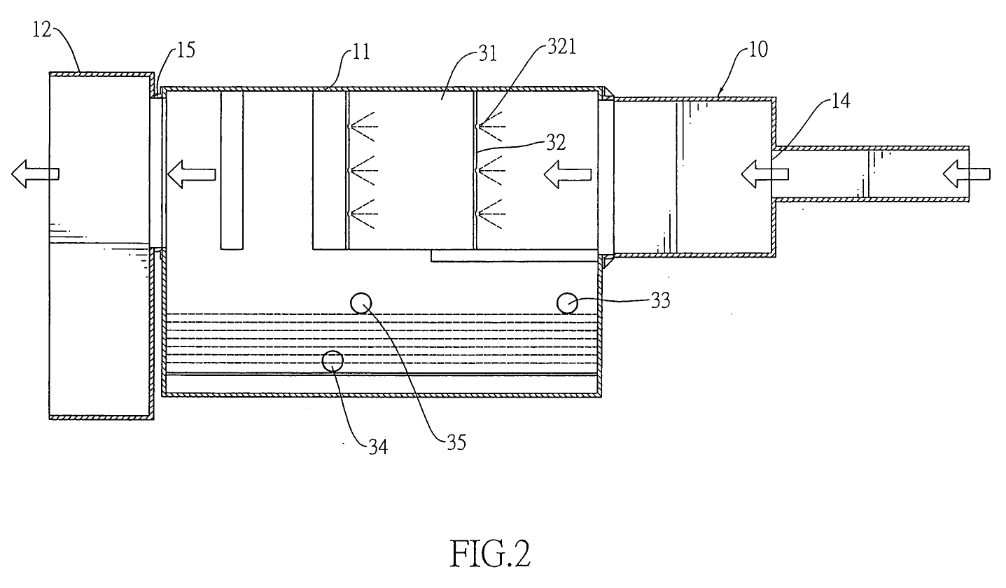

With reference to FIGS. 1 and 2, an air purifier in accordance with the present invention for an industrial plant including but not limited to an oil refinery or an incinerator comprises an air duct (10), an air pump (20), a water cleaner (30) and an ultraviolet (UV) cleaner (40).

The air duct (10) is hollow and has two ends, an air outlet (13), an air inlet (14), a first duct casing (11), a second duct casing (12) and a connecting tube (15).

The air outlet (13) is formed at one end of the air duct (10). The air inlet (14) is formed at the other end of the air duct (10) relative to the air outlet (13).

The first duct casing (11) is connected to the air inlet (14), has a top and a bottom and may be cylindrical.

The second duct casing (12) is connected to the air outlet (13) and has a top.

The first duct casing (11) and second ducting casing (12) are bigger than the air outlet (13), air inlet (14) and connecting tube (15). The connecting tube (15) connects the tops of the first and second duct casings (11, 12).

The air pump (20) is connected to the air outlet (13) of the air duct (10) and generates a suction force to pull air through the air purifier. The air pump (20) may be a blower mounted outside the air outlet (13) and comprises a motor (22), a transmission and a fan (21). The fan (21) is driven by the motor (22) through the transmission.

The water cleaner (30) is mounted in the first duct casing (11) removes particles from air passing therethrough and has a cavity (31), multiple sprinkling tubes (32), an inlet hose (33), an outlet hose (34), and an optional overflow hose (35).

The cavity (31) is formed in the first duct casing (11) of the air duct (10) adjacent to the air inlet (14).

Each sprinkling tube (32) is mounted in the cavity (31) of the water cleaner (30) and may be connected to an external water source to spray water. Each sprinkling tube (32) has multiple nozzles (321). The nozzles (321) are formed in the sprinkling tube (32) face the air inlet (14) of the air duct (10) and may spray water to contain pollutant particles in the air.

The inlet hose (33) is mounted through the first duct casing (11) of the air duct (10) and communicates with the cavity (31) of the water cleaner (30) and may be connected to an external water source to pour water into the cavity (31) of the water cleaner (30) and form a water pool at the bottom of the first air duct (11). The water pool may interact with turbulent air in the first air duct (11) to remove particles from the air.

The outlet hose (34) is mounted through the first duct casing (11) of the air duct (10), communicates with the cavity (31) of the water cleaner (30) and may discharge water out of the cavity (31) of the water cleaner (30). After the sprinkled water absorbs the pollutant particles in the water and falls down to mix with the clean water from the inlet hose (33), the outlet hose (34) discharges the contaminated water mixed with the pollutant particle out of the first duct casing (11) and may transport the dirty water for further cleaning, filtering or the like.

The overflow hose (35) is mounted through the first duct casing (11) of the air duct (10) above the outlet hose (34), communicates with the cavity (31) of the water cleaner (30) and may discharge water out of the cavity (31) if a water level is too high and may communicate with the outlet hose (34) and transport the water for further cleaning, filtering or the like.

Dirty air enters the water cleaner (30) through the air inlet (14) and is slowed and the water passes therethrough. Therefore, particulates are removed from the dirty air and are suspended in the water. Some gases are also absorbed by the water. Therefore, the dirty air is partially cleaned before traveling through the connecting tube (15).

The UV cleaner (40) cleans and purifies the dirty air and has multiple UV generators (41). The UV generators (40) may be UV light tubes (41), are mounted in the second duct casing (12) of the air duct (10) and generate two types of UV when operating, the two types may be long and short UV. Short UV has a wavelength ranging from 160 to 200 nanometer (nm) and long UV has a wavelength ranging from 220 to 300 nm. The two types of the UV decompose most kinds of pollutants such as volatile organic compounds (VOCs), nitroxides (NOx) and sulfoxides (SOx) and eliminate bacteria in the dirty air from the industrial plant. The pollutants in the air irradiated by the UV generators (40) are converted to ions and to non-harmful gases turn into non-toxic, tasteless materials that do not cause harm to people and the environment. The air purifier as described has the water cleaner (30) sprinkling water to absorb pollutants in the air and the UV cleaner (40) to decompose the pollutants. The dirty air passes slowly through the first duct casing (11) of the air duct (10) and the second duct casing (12) of the air duct (10). Therefore, the dirty air in the air duct has enough reactive time to be turned into clean air. Furthermore, the air purifier without any air-cleaning agents neither produces smells nor causes discomfort to people nor leaves air cleansing agents in the air to endanger people and the environment.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An air purifier for industrial plants comprising
an air duct being hollow and having
two ends;
an air outlet being formed at one end of the air duct;
an air inlet being formed at the other end of the air duct relative to the air outlet;
a first duct casing connecting to the air inlet and being bigger than the air outlet;
a second duct casing connecting to the air outlet and being bigger than the air outlet; and
a connecting tube being connected to the first duct casing and the second duct casing and being smaller then the first and second air ducts;
an air pump being connected to the air outlet of the air duct;
a water cleaner being mounted in the first duct casing; and
an ultraviolet (UV) cleaner being mounted in the second duct casing.

2. The air purifier as claimed in claim 1, wherein the water cleaner further has
a cavity being formed in the first duct casing of the air duct;
multiple sprinkling tubes being mounted in the cavity of the water cleaner and each sprinkling tube having multiple nozzles formed in the sprinkling tube;
an inlet hose being mounted through the first duct casing of the air duct and communicating with the cavity of the water cleaner; and
an outlet hose being mounted through the first duct casing of the air duct and communicating with the cavity of the water cleaner.

3. The air purifier as claimed in claim 1, wherein the UV cleaner has multiple UV generators.

4. The air purifier as claimed in claim 2, wherein the nozzles in each sprinkling tube face the air inlet of the air duct.

5. The air purifier as claimed in claim 2, wherein the water cleaner further has an overflow hose being mounted through the duct casing of the water cleaner above the outlet hose and communicating with the first duct casing of the air duct.
